(19) United States
(12) Patent Application Publication
(10) Pub. No.: US 2025/0188274 A1
(43) Pub. Date: Jun. 12, 2025

(54) LOW VOLATILE ORGANIC COMPOUND (VOC) THERMOPLASTIC COMPOSITION

(71) Applicant: SABIC GLOBAL TECHNOLOGIES B.V., Bergen op Zoom (NL)

(72) Inventors: Sangita Nandi, Bengaluru (IN); Anirban Ganguly, Bangalore (IN); Sudha Tantry, Bengaluru (IN); Kevin Di, Shanghai (CN); Susanta Mitra, Bangalore (IN)

(21) Appl. No.: 18/846,328

(22) PCT Filed: Mar. 16, 2023
(86) PCT No.: PCT/EP2023/056757

§ 371 Date: Sep. 12, 2024

(30) Foreign Application Priority Data
Mar. 17, 2022 (EP) 22162779.7

(51) Int. Cl. C08L 69/00; C08L 47/00

(52) U.S. Cl. CPC C08L 69/00; C08L 47/00; C08L 2203/206

(57) ABSTRACT

The present invention relates to a thermoplastic composition comprising, based on the weight of the composition, (A) 75.0 to 98.9 wt. % of aromatic polycarbonate, (B) 1.0 to 20.0 wt. % of at least one hydrogenated block copolymer which comprises at least one vinyl aromatic polymer block, and at least one hydrogenated diene polymer block and (C) 0.1 to 5.0 wt. % of at least one additive. wherein the combined amounts of (A), (B) and (C) is 100 wt. %. The present invention further relates to an article comprising or consisting of such a composition.

The present invention relates to a thermoplastic composition comprising aromatic polycarbonate and impact modifier. The present invention further relates to an article comprising or consisting of such a composition.

Compositions comprising polycarbonate and acrylonitrile-butadiene-styrene copolymer (PC/ABS) are widely used in automotive interior parts. Such compositions combine the properties of PC and ABS, such as the heat-resistance and low temperature impact resistance. PC/ABS compositions exhibit a good balance of low-temperature toughness, rigidity, dimensional stability, excellent creep resistance, low moisture absorption and good heat resistance. This combination makes PC/ABS suitable material for appliances, automotive interior and exterior articles, electrical and or electronic articles, consumer products, medical equipment, computer and (tele) communication applications.

The inventors found that at least some PC/ABS compositions release unpleasant odors during the course of production and/or use. ABS is generally manufactured through emulsion polymerization and often contains small molecules as impurities, which produce volatile organic compounds (VOC) and accordingly an unpleasant odor. As a result, a variety of automotive interior parts manufactured from PC/ABS compositions emit VOCs in which the most common odor compounds are benzene, toluene, ethylbenzene, acetaldehyde, formaldehyde, ethanol, styrene, ethyl acetate, etc. With increasing numbers of automobiles on road, the problem of air safety in automobiles is particularly prominent. Therefore, improvement of the quality of air in the vehicle is at present an urgent need for the health of the driver and passengers. Thus, in recent years, different Vehicle Interior Air Quality (VIAC) regulations have increased awareness on health leading to strict thresholds on VOC and odor performance of auto interiors materials. There is constant research in the art to develop a low VOC high performance PC/ABS composition to meet such requirements.

CN103554867A discloses a low-VOC PC/ABS alloy material that contains: by weight, 30-80 parts of polycarbonate, 5-50 parts of a styrene-butadiene-acrylonitrile copolymer, 5-30 parts of a styrene-acrylonitrile copolymer, 1-10 parts of a compatibiliser, 0.1-1.0 part of an odor absorbent and 0.1-1 part of a processing agent.

CN111087745A discloses a PC/ABS alloy material, in particular to a low-odor 3D printing PC/ABS alloy material comprising an odor removing agent and a preparation method and application thereof.

CN104559111A discloses low-odor and low-emission PC/ABS alloy material comprising a novel chemical deodorant and an adsorption type physical adsorbent, which improve the overall odor and total carbon emission properties of the polycarbonate alloy material.

CN103709704B discloses a low smell PC/ABS alloy comprising high flux foaming PP jellyfish grains that acts as an air lift agent, effectively removing the various volatile small molecule and organic compound that is produced in the course of processing.

JP2014181323 discloses a composition comprising (A) 50 to 90 parts by weight of polycarbonate resin and (B) 10 to 50 parts by weight of polypropylene resin, (C) 1 to 20 parts by weight of a styrenic thermoplastic elastomer (C component), wherein the ratio of the melt flow rate (MFR) of the B component and the C component is from 0.5-3.

EP 0119533 discloses a resin mixture comprising (a) an aromatic polycarbonate resin; and (b) a modifier combination therefor comprising (i) a selectively hydrogenated linear, sequential, or radial teleblock copolymer resin of a vinyl aromatic compound (A)ₙ and (A′)n and an olefinic elastomer (B), of the A-B-A′, A-(B-A-B)ₙ-A; A(BA)ₙB; (A)₄B; B(A)₄; or B ((AB)ₙB)₄ type, wherein n is an integer of from 1 to 10; (ii) a copolymer of an olefin and at least one of a C₁-C₆ alkyl acrylate, a C₁-C₆ alkyl methacrylate acrylic acid, methacrylic acid, or mixtures of any of the foregoing, said modifier being present in said mixture in an amount at least sufficient to impart to said mixture a resistance to environmental stress crazing and cracking greater than that possessed by said polycarbonate resin.

WO 2016/100660 discloses A polymer composition comprising a) from about 55 wt. % to about 85 wt. % polycarbonate polymer; b) from about 10 wt. % to about 40 wt. % polypropylene polymer; and c) from about 2 wt. % to about 15 wt. % of a compatibiliser comprising (i) a polymer having styrene and ethylene/butylene blocks, (ii) a triblock copolymer, (iii) hydrogenated styrene isoprene copolymer, or (iv) mixtures thereof. U.S. Pat. No. 5,539,030 discloses an improved composition of matter of the type which comprises, in admixture, (a) polycarbonate; (b) a blend of poly(phenylene ether) with a copolymer prepared from a vinyl aromatic compound and a diene; and (c) a grafted, rubber-modified copolymer prepared from a vinyl aromatic compound and a vinyl nitrile compound; wherein the poly(phenylene ether) is present in the composition in an amount of about 0.2 weight parts to about 5 weight parts, by weight of the total composition.

PC/ABS compositions comprising various auxiliary agents like porous odor adsorbents, chemical odor absorbents, chemical deodorants or masking agents have been disclosed in prior art, which help in reducing VOC and/or masking unpleasant odor. However, there is a problem of higher cost, compatibility of the auxiliary agent with the processing conditions and the like.

It is, therefore, an object of the invention to provide for a composition comprising polycarbonate that has a low VOC combined with good impact resistance properties, in particular good low temperature impact resistance properties.

To that extent the present inventors have surprisingly found that a composition comprising polycarbonate and a hydrogenated block copolymer (HBC), wherein said HBC comprises at least one vinyl aromatic polymer block and at least one hydrogenated diene polymer block, demonstrates a low VOC in combination with good low temperature impact resistance. Without willing to be bound to it, the present inventors believe that neat HBC inherently has low VOC compared to neat ABS.

Accordingly the present invention relates to a thermoplastic composition comprising, based on the weight of the composition,
A) 75.0 to 98.9 wt. % of aromatic polycarbonate,
(B) 1.0 to 20.0 wt. % of at least one hydrogenated block copolymer which comprises at least one vinyl aromatic polymer block, and at least one hydrogenated diene polymer block and
(C) 0.1 to 5.0 wt. % of at least one additive
wherein the combined amounts of (A), (B) and (C) is 100 wt. %.

More specifically the present invention is directed at a thermoplastic composition comprising, based on the weight of the composition,
A) 75.0 to 98.9 wt. % of aromatic polycarbonate,
(B) 1.0 to 20.0 wt. % of at least one hydrogenated block copolymer which comprises at least one vinyl aromatic polymer block, and at least one hydrogenated diene polymer block and
(C) 0.1 to 5.0 wt. % of at least one additive
wherein the combined amounts of (A), (B) and (C) is 100 wt. % and wherein, the composition has a total VOC of less than 75 mg/g.

By application of the invention, the foregoing object is met, at least in part.

The invention will now be described in more detail.

### Polycarbonate (PC)

Polycarbonate is a well-known material and generally exhibits good mechanical and optical properties. Typical applications include optical media carriers, glazing, extruded sheets, lenses and water bottles. Polycarbonates are generally manufactured using two different technologies. In a first technology, known as the interfacial technology or interfacial process, phosgene is reacted with bisphenol A (BPA) in a liquid phase. Another well-known technology for the manufacture of polycarbonate is the so-called melt technology, sometimes also referred to as melt transesterification or melt polycondensation technology. In the melt technology, or melt process, a bisphenol, typically BPA, is reacted with a carbonate, typically diphenyl carbonate (DPC), in the melt phase. A polycarbonate obtained by the melt transesterification process is known to be structurally different from polycarbonate obtained by the interfacial process. In that respect it is noted that in particular the so called “melt polycarbonate” typically has a minimum amount of Fries branching, which is generally absent in “interfacial polycarbonate”. Apart from that, melt polycarbonate typically has a higher number of phenolic hydroxy end groups while polycarbonate obtained by the interfacial process is typically end-capped and has at most 150 ppm, preferably at most 50 ppm, more preferably at most 10 ppm of phenol hydroxyl endgroups.

The thermoplastic composition of the present invention comprises 75.0 to 98.9 wt. %, preferably 85.0 to 98.9 wt. % of aromatic polycarbonate, based on the weight of the composition. Further, it is preferred that the aromatic polycarbonate comprises or consists of bisphenol A polycarbonate homopolymer (also referred to herein as bisphenol A polycarbonate). Preferably the aromatic polycarbonate does not comprise polycarbonate copolymer(s). Preferably, the aromatic polycarbonate of the invention disclosed herein comprises at least 60 wt. %, preferably at least 75 wt. %, more preferably at least 85 wt. %, at least 95 wt. % or 99 wt. % of bisphenol A polycarbonate based on the total amount of aromatic polycarbonate. More preferably, the aromatic polycarbonate in the composition essentially consists or consists of bisphenol A polycarbonate. It is preferred that the composition does not comprise a polyolefin, such as polyethylene, polypropylene or ethylene-propylene copolymers r mixtures thereof.

It is preferred that the aromatic polycarbonate has a weight average molecular weight of 15,000 to 60,000 g/mol, more preferably 20,000 to 40,000 g/mol determined using gel permeation chromatography with polystyrene standards.

In an aspect, the aromatic polycarbonate is an interfacial polycarbonate.

In another aspect, the aromatic polycarbonate is a melt polycarbonate.

In yet another aspect the aromatic polycarbonate is a mixture of from 20-80 wt. % of interfacial polycarbonate and from 80-20 wt. % of melt polycarbonate.

The aromatic polycarbonate may also be a mixture of two or more otherwise identical aromatic polycarbonates differing in melt volume rate (i.e. in molecular weight). For example, the aromatic polycarbonate may be a mixture of two or more bisphenol A polycarbonate homopolymers with mutually different weight average molecular weight.

### Hydrogenated Block Copolymer (HBC)

HBCs, in accordance with the present invention, comprises or consists of a vinyl aromatic polymer based hard block and a hydrogenated diene polymer based soft block. They exhibit rubber elasticity since the hard block acts as a crosslinking point below the glass transition temperature (T_{g}) of the vinyl aromatic polymer and the soft block provides elasticity. HBCs are typically prepared by hydrogenating a block copolymer produced from a vinyl aromatic monomer and a diene monomer. HBC's are known in the art per se

The vinyl aromatic monomer is typically a monomer of the formula

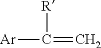

wherein R′ is hydrogen or alkyl, Ar is phenyl, halophenyl, alkylphenyl, alkylhalophenyl, or naphthyl, wherein any alkyl group contains 1 to 6 carbon atoms which may be mono or multisubstituted with functional groups such as halo, nitro, amino, hydroxy, cyano, carbonyl and carboxyl. More preferably Ar is phenyl or alkyl phenyl with phenyl being most preferred.

The diene monomer may include for example 1,3-butadiene, 2-methyl-1,3-butadiene, 2-methyl-1,3 pentadiene, isoprene and similar compounds, and mixtures thereof.

Methods of making block copolymers comprising blocks based on polymerization of the diene monomer are well known in the art. After preparation of the block copolymer, the same may be hydrogenated, for example by dissolving the obtained block copolymer in a solvent inert to a hydrogenation catalyst and allowing it to react with hydrogen in the presence of a hydrogenation catalyst to form the hydrogenated block copolymers (HBCs). Typical methods are described in U.S. Pat. No. 6,815,475B2 and the references incorporated therein. Preferably the solvent is a saturated solvent such as cyclohexane, methylcyclohexane, ethylcyclohexane, cyclooctane, cycloheptane, dodecane, dioxane, diethylene glycol dimethyl ether, tetrahydrofuran, isopentane, decahydronaphthalene or mixtures thereof, with cyclohexane being the most preferred. Such methods typically use metal catalysts supported on an inorganic substrate, such as palladium (Pd) on BaSO₄. Typical hydrogenation temperatures are from about 40° C., preferably from about 100° C., more preferably from about 200° C. Most preferably the temperature are between 120° C. to 250° C. The pressure of the hydrogenation reaction is typically from atmospheric pressure to 70 MPa, with 0.7 to 10.3 MPa being preferred. The present invention is however, not limited to this way of hydrogenation per se

The thermoplastic composition disclosed herein comprises, based on the weight of the composition, from 1.0 to 20.0 wt. % of at least one hydrogenated block copolymer. Preferably, the amount of hydrogenated block copolymer is from 5.0 to 15.0 wt. %. The hydrogenated block copolymer comprises at least one vinyl aromatic polymer block, and at least one hydrogenated diene polymer block. The HBC may further comprise recycled and/or circular renewable HBCs.

Typical vinyl aromatic monomers include styrene, alpha-methylstyrene, all isomers of vinyl toluene (viz. o′-, m′-, p′-vinyl toluene), all isomers of ethyl styrene (viz. 2-ethystyrene, 4-ethylstyrene), propyl styrene, butyl styrene, and mixtures thereof. The vinyl aromatic polymer block may be preferably selected from the group consisting of polystyrene, alpha-methylstyrene polymer, vinyl toluene polymer, ethyl styrene polymer, propyl styrene polymer, butyl styrene polymer, styrene-alpha-methylstyrene copolymer and styrene-vinyl toluene copolymer. The hydrogenated diene polymer block is preferably selected from the group consisting of hydrogenated polybutadiene, hydrogenated polypentadiene, hydrogenated polyisoprene, and a hydrogenated copolymer of butadiene and isoprene.

The hydrogenated block copolymer in the present invention preferably has a weight ratio of hydrogenated diene polymer block to vinyl aromatic polymer block from 90:10 to 30:70, preferably 70:30 to 40:60 based on the total weight of the hydrogenated diene polymer block and the vinyl aromatic polymer block. Each hydrogenated diene polymer block has a hydrogenation level of at least 95%. For example, the hydrogenation level may be from 95-99.9%. Preferably the hydrogenated diene block is fully hydrogenated, hence having a hydrogenation level of 100%. The term ‘level of hydrogenation’ refers to the percentage of the original unsaturated bonds which become saturated upon hydrogenation. The level of hydrogenation is determined using proton NMR.

The weight average molecular weight of the HBC is preferably from 70,000 to 450,000 g/mol, preferably from 90,000 to 400,000 g/mol, more preferably from 100,000 to 300,000 g/mol as determined using gel permeation chromatography with polystyrene standards. The molecular weight of the HBC is dependent upon the molecular weight of each of the polymeric blocks. It is understood that each individual block of the HBC according to the present invention, can have its own distinct molecular weight. In other words, for example, two vinyl aromatic polymer blocks within the HBC may each have a different molecular weight. For example, each vinyl aromatic polymer block may have a molecular weight from 6,000 to 70,000 and each hydrogenated diene polymer block may have a molecular weight from 3,000 to 50,000.

Examples of the hydrogenated block copolymers used in the present invention include, triblock, multiblock, tapered block, and star block copolymers such as selected from styrene-ethylene-propylene (SEP), styrene-ethylene-propylene-styrene (SEPS), styrene-ethylene-butylene-styrene (SEBS) and styrene-ethylene-ethylene-propylene-styrene (SEEPS) block copolymers and the like. Preferably, the HBCs may contain at least one triblock copolymer comprised of a vinyl aromatic polymer block on each end. The HBCs can also be branched, wherein polymer chains are attached to the individual blocks at any point along the copolymer backbone. The hydrogenated block copolymers used in the present invention, are typically “obtained by” hydrogenating the respective diene based polyolefin blocks, as commonly known in prior art.

### Additives

Typical additives that are used in the composition can comprise one or more of a flow modifier, filler, reinforcing agent (e.g., glass fibers or glass flakes), antioxidant, heat stabilizer, light stabilizer, UV light stabilizer and/or UV absorbing additive, plasticizer, lubricant, release agent, in particular glycerol monostearate, pentaerythritol tetra stearate, glycerol tristearate, stearyl stearate, antistatic agent, antifog agent, antimicrobial agent, colorant (e.g., a dye or pigment), flame retardant either or not combined with an anti-drip agent such as polytetrafluoroethylene (PTFE) or PTFE encapsulated in styrene-acrylonitrile copolymer.

The compositions can be manufactured by various methods known in the art. For example, polycarbonate, HBC, and other additives are first blended, in a high-speed mixer or by hand mixing. The blend is then fed into the throat of a twin-screw extruder via a hopper. Alternatively, at least one of the components can be incorporated into the composition by feeding it directly into the extruder at the throat and/or downstream through a side feeder, or by being compounded into a masterbatch with a desired polymer and fed into the extruder. For example, compositions can be prepared using a Krupp Werner & Pfleiderer ZSK2 co-rotating intermeshing 10-barrel twin screw extruder of diameter 25 mm and L/D ratio 40. The temperature in the extruder may be from 180° C.-265° C. along the screw length. The extrudate can be immediately cooled in a water bath and pelletized. The pellets so prepared can be 0.6 cm in length or less as desired. Such pellets can be used for subsequent molding, shaping, or forming.

Shaped, formed, or molded articles comprising the compositions are also provided. The compositions can be molded into articles by a variety of methods, such as injection molding, extrusion, and thermoforming. Some example of articles include automotive and vehicular interior articles or a housing for electrical equipment. Such article is comprised in or constitutes any one or more selected from the group consisting of instrument panels, cup holders, glove boxes, dashboards, dashboard carriers, door claddings, door fixtures, armrests, pillar cladding, seat cladding, boot cladding and parts used in heating, ventilation and/or air conditioning instruments.

Accordingly, the present invention relates to an article comprising or consisting of the composition disclosed herein. More in particular, the present invention relates to vehicular interiors articles or for housing of electrical equipment comprising or consisting the composition disclosed herein. Likewise, the present invention relates to a vehicle or an electrical equipment comprising said vehicular article or said housing. The present invention relates to the use of the composition disclosed herein for the manufacture of an article of manufacture, such as an automotive article.

In use the surface of the article is typically not or only partially coated or otherwise provided with a further layer. Preferably at least 40%, more preferably at least 60% of the surface of the article consisting of the composition disclosed herein is exposed to the surrounding atmosphere.

### Composition

In the composition the amount of aromatic polycarbonate is preferably from 80 wt. %-90 wt. % and the amount of hydrogenated block copolymer is preferably from 5.0-15.0 wt. %, both based on the weight of the composition.

The weight ratio of hydrogenated diene polymer block to vinyl aromatic polymer block is preferably from 90:10 to 30:70, preferably from 70:30 to 40:60 based on the total weight of the hydrogenated diene polymer block and the vinyl aromatic polymer block.

For the avoidance of doubt the skilled person will understand that the total weight of the composition will be 100 wt. % and that any combination of materials which would not form 100 wt. % in total is unrealistic and not according to the invention. Thus, the total of the components, being (A) aromatic polycarbonate, (B) at least one hydrogenated block copolymer comprising at least one vinyl aromatic polymer block and at least one hydrogenated diene polymer block and (C) additive(s), wherein the combined amounts of (A), (B) and (C) is 100 wt. %. Preferably the combined amounts of (A) and (B) is at least 97 wt. %, preferably at least 98 wt. %, more preferably at least 99 wt. % or 99.5 wt. %.

Preferably the at least one additive (C), and accordingly the composition, does not comprise a poly(phenylene ether).

While the invention is disclosed herein with reference to a hydrogenated block copolymer the present invention also extends to otherwise identical block copolymers which are not obtained by means of a hydrogenation process.

Accordingly in a further aspect 1, the present invention also relates to a thermoplastic composition comprising, based on the weight of the composition,
(A) 75.0 to 98.9 wt. % of aromatic polycarbonate,
(B) 1.0 to 20.0 wt. % of at least one block copolymer which comprises at least one vinyl aromatic polymer block, and at least one saturated polyolefin block and
(C) 0.1 to 5.0 wt. % of at least one additive,
wherein the combined amounts of (A), (B) and (C) is 100 wt. %.

Further aspect 2: With regards to further aspect 1 it is preferred that in the block copolymer a weight ratio of saturated polyolefin to vinyl aromatic polymer block is from 90:10 to 30:70.

Further aspect 3: With regards to further aspects 1 or 2 it is preferred that the vinyl aromatic polymer block is selected from the group consisting of polystyrene, alpha-methylstyrene polymer, vinyl toluene polymer, ethyl styrene polymer, propyl styrene polymer, butyl styrene polymer, styrene-alpha-methylstyrene copolymer and styrene-vinyl toluene copolymer.

Further aspect 4: With regards to further aspects 1-3 it is preferred that the saturated polyolefin block is selected from the group consisting of polyethylene, polypropylene, ethylene-propylene copolymer, ethylene-butene copolymer, ethylene-hexene copolymer, ethylene-octene copolymer and terpolymers of ethylene and at least two comonomers selected from propylene, butene, hexene and octene.

Further aspect 5: With regards to further aspects 1-4 it is preferred that the amount of saturated polyolefin block is from 5.0-15.0 wt. % based on the weight of the block copolymer.

Further aspect 6: With regards to further aspects 1-5 it is preferred that the weight average molecular weight of the block copolymer is from 70,000 to 160,000 g/mol determined using gel permeation chromatography with polystyrene standards.

All properties and/or other preferred aspects of the invention disclosed herein with regards to compositions based hydrogenated block copolymer shall also apply to the further aspects 1-6 defined above.

### Properties

It was surprisingly found that thermoplastic composition comprising aromatic polycarbonate homopolymer and HBCs as described above, shows low VOC, while showing comparable or improved room temperature and low temperature impact resistance.

In accordance with the invention, the thermoplastic composition as disclosed herein has or is selected to have a total VOC of less than 75 mg/g, determined in accordance with the method disclosed herein below. Preferably, the thermoplastic composition of the present invention has or is selected to have a total VOC from 10 mg/g to 60 mg/g as determined in accordance with the method as described below, under Test Methods.

Furthermore, the thermoplastic composition as disclosed herein has or is selected to have a heat distortion temperature (HOT) of at least 110° C., as determined by ISO 75 standard flatwise at a load of 0.45 MPa. Preferably the thermoplastic composition of the present invention has or is selected to have a HOT from 110° C. to 130° C.

The present invention will now be further elucidated based on the following non-limiting examples.

### Test Methods

| | |
|---|---|
| Impact | Notched Izod impact (NII) properties were determined in |
| | accordance with ISO 180/1A on injection molded samples being |
| | 80 × 10 × 4 mm in size. The test was carried out at different |
| | temperatures 23° C. and −30° C. The impact strength is expressed |
| | in kJ/m2. The test result is the average of 5 specimens. |
| Molecular weight | The molecular weight of the polycarbonate and hydrogenated |
| | block copolymer was measured by GPC method with polystyrene |
| | standard in an Agilent 1260 Infinity (SYS-LC-1260) equipment |
| | with PLGel 5 μm Minimix C 250 × 4.6 mm column and Refractive |
| | Index detector. The sample is dissolved in dichloromethane and |
| | the same solvent is used as carrier. |
| Heat distortion | The heat distortion temperature, HDT (in ° C.) was determined in |
| temperature (HDT) | accordance with ISO 75 flatwise at a load of 0.45 MPa. |
| Tensile modulus | The tensile modulus (in units of Gigapascals; GPa) and % nominal |
| | strain at break were tested according to ISO 527/2012 measured |
| | at room temperature (23° C.). |
| Tensile strength | Tensile strength (in units of Megapascals: MPa) and % elongation |
| | were tested according to ISO 527/2012 measured at room |
| | temperature (23° C.). |
| Glass transition | Glass transition temperatures were determined by dual cantilever |
| temperature (T_{g}) | three point bending dynamic mechanical analyzer wherein the |
| | temperature was cycled from 23° C. to 250° C. and frequency of |
| | 6.28 rad/sec. |
| Melt volume rate | The melt volume rate was determined in accordance with ISO |
| (MVR) | 1133. For polycarbonate, measurements were carried out at a |
| | temperature of 300° C. and a load of 1.2 kg. For the compositions, |
| | measurements were carried out at a temperature of 250° C. and a |
| | load of 5.0 kg. |
| Volatile Organic | The VOC was determined using a Head Space Gas |
| Content (VOC) | Chromatography Mass spectroscopy (HS-GCMS) technique. |
| | 4 gram of a sample in pellet form was heated at 80° C. for 30 |
| | minutes is a closed vessel having a volume of 20 mL. |
| | The volatiles were separated using a CP-WAX-52CB, 50 m × |
| | 0.320 mm (ID) × 1.25 μm thickness fused silica capillary column |
| | in s Shimadzu HS-GCMS instrument and quantified using a flame |
| | ionisation detector. |
| | Volatile organic contents were detected and identified using mass |
| | detector. Using external standards the known volatile components |
| | (such as ethyl acetate, toluene, ethyl benzene, styrene, |
| | benzaldehyde) were quantified. Other organic contents were |
| | quantified yet could not be qualified accurately; these organic |
| | contents were together referred to as “unknown VOC”. |
| | The total VOC as reported herein is the sum of the amounts of all |
| | the known and the unknown detected organic content. |

### EXAMPLES

The samples were molded by injection molding on L&T ASWA 100T Injection molding machine at 260° C., keeping the mold temperature set at 70° C. for all compositions. The components of the compositions and their source are listed in Table 1.

TABLE 1
Components of the compositions and their source

| | |
|---|---|
| PC1 | Bisphenol A polycarbonate manufactured using an interfacial process, having |
| | a melt volume rate of 6 cc/10 min (ISO 1133, 300° C., 1.2 kg) and weight |
| | average molecular weight = 58,000 g/mol (with polystyrene standard) |
| | available from SABIC (PC 105) |
| PC2 | Bisphenol A polycarbonate manufactured using an interfacial process, having |
| | a melt volume rate of 6 cc/10 min (ISO 1133, 300° C., 1.2 kg) and weight |
| | average molecular weight = 42,000 g/mol (with polystyrene standard) |
| | available from SABIC (PC 175) |
| PC3 | Polycarbonate produced via the melt transesterification of diphenyl carbonate |
| | and bisphenol A, and having a MVR of 22 cc/10 min, and an amount of Fries |
| | branching of ~ 1100 ppm and available from SABIC. |
| PC4 | Polycarbonate produced via the melt transesterification of diphenyl carbonate |
| | and bisphenol A, and having a MVR of 6 cc/10 min, and an amount of Fries |
| | branching of ~ 1100 ppm and available from SABIC. |
| ABS | Acrylonitrile Butadiene Styrene terpolymer (17 wt. % butadiene, 15 wt. % |
| | acrylonitrile and the remaining styrene) prepared using bulk polymerization |
| | method available from SABIC (BABS 29449) |
| HBC 1 | Septon ™ 4077 commercially available from Kuraray (30% styrene containing |
| | SEEPS) (molecular weight = 407,213 g/mol with polystyrene standard) |
| HBC 2 | Septon ™ 4055 commercially available from Kuraray (30% styrene containing |
| | SEEPS) (molecular weight = 307,046 g/mol with polystyrene standard) |
| HBC 3 | Septon ™ 4033 commercially available from Kuraray (30% styrene containing |
| | SEEPS) (molecular weight = 102,533 g/mol with polystyrene standard) |
| HBC 4 | Septon ™ 2006 commercially available from Kuraray (30% styrene containing |
| | SEPS) (molecular weight = 290,144 g/mol with polystyrene standard) |
| HBC 5 | Septon ™ 2063 commercially available from Kuraray (13% styrene containing |
| | SEPS) (molecular weight = 147,703 g/mol with polystyrene standard) |
| HBC 6 | Septon ™ 2104 commercially available from Kuraray (65% styrene containing |
| | SEPS) (molecular weight = 275,000 g/mol with polystyrene standard) |
| HBC 7 | Septon ™ 1020 commercially available from Kuraray (30% styrene containing |
| | SEP) (molecular weight = 97,000 g/mol with polystyrene standard) |
| BC 1 | Hybrar ™ 5125 (20% styrene containing vinyl bond rich SIS) commercially |
| | available from Kuraray (Tg = −13° C.) |
| BC 2 | Hybrar ™ 7311 (12% styrene containing vinyl bond rich SEEPS) commercially |
| | available from Kuraray (Tg = −32° C.) |
| PETS | Pentaerythritol tetra stearate from Imerys |
| AO1 | Primary antioxidant, Pentaerythritol tetrakis(3-(3,5-di-tert-butyl-4- |
| | hydroxyphenyl)propionate), CAS 6683-19-8, Commercially available as |
| | Irganox 1010 |
| AO2 | Secondary antioxidant, tris(2,4-di-tert.-butylphenyl)phosphite, CAS 31570- |
| | 04-4, commercially available from BASF as Irgafos 168 |

### Comparative Example (CE1) and Examples (E1-E9): Table 2

TABLE 2
Formulations and properties for the PC - HBC compositions

| Components | | | | | | | | | | | | | | |
|---|---|---|---|---|---|---|---|---|---|---|---|---|---|---|
| (wt. %) | CE 1 | E 1 | E 2 | E 3 | E 4 | E 5 | E 6 | E 7 | E8 | E9 | E10 | E11 | E12 | E13 |
| PETS | 0.4 | 0.4 | 0.4 | 0.4 | 0.4 | 0.4 | 0.4 | 0.4 | 0.4 | 0.4 | 0.4 | 0.4 | 0.4 | 0.4 |
| AO 1 | 0.1 | 0.1 | 0.1 | 0.1 | 0.1 | 0.1 | 0.1 | 0.1 | 0.1 | 0.1 | 0.005 | 0.005 | 0.005 | 0.005 |
| AO 2 | 0.1 | 0.1 | 0.1 | 0.1 | 0.1 | 0.1 | 0.1 | 0.1 | 0.1 | 0.1 | 0.1 | 0.1 | 0.1 | 0.1 |
| PC1 | 42.5 | 52.5 | 52.5 | 52.5 | 52.5 | 52.5 | 52.5 | 52.5 | 55.5 | 46.7 | 0.1 | 0.1 | 0.1 | |
| PC2 | 29.9 | 36.9 | 36.9 | 36.9 | 36.9 | 36.9 | 36.9 | 36.9 | 38.9 | 32.7 | 55.5 | 52.5 | 52.5 | |
| PC3 | | | | | | | | | | | | | | 42.5 |
| PC4 | | | | | | | | | | | | | | 36.9 |
| ABS | 27 | | | | | | | | | | | | | |
| HBC 1 | | 10 | | | | | | | | | | | | |
| HBC 2 | | | 10 | | | | | | | | 5 | | | 10 |
| HBC 3 | | | | 10 | | | | | 5 | 20 | | | | |
| HBC 4 | | | | | 10 | | | | | | | | | |
| HBC 5 | | | | | | 10 | | | | | | | | |
| HBC 6 | | | | | | | 10 | | | | | | | |
| HBC 7 | | | | | | | | 10 | | | | | | |
| BC 1 | | | | | | | | | | | | 10 | | |
| BC 1 | | | | | | | | | | | | | 10 | |
| TOTAL | 100 | 100 | 100 | 100 | 100 | 100 | 100 | 100 | 100 | 100 | 100 | 100 | 100 | 100 |

| | CE 1 | E 1 | E 2 | E 3 | E 4 | E 5 | E 6 | E 7 | E8 | E9 | E10 | E11 | E12 | E13 |
|---|---|---|---|---|---|---|---|---|---|---|---|---|---|---|
| ISO NII @ 23° C. (J/m²) | 55.7 | 56.3 | 57.1 | 58.4 | 57.7 | 64.5 | 92.7 | 52.3 | 47.4 | 66.9 | 57.1 | 73.8 | 66.4 | 55.3 |
| ISO NII @ −30° C. | 25.6 | 37.0 | 50.8 | 32.3 | 55.8 | 62.5 | 33.4 | 45.2 | 28.3 | 49.0 | 35.0 | 23.7 | 38.5 | 33.1 |
| (J/m²) | | | | | | | | | | | | | | |
| % Retention of impact | 46.0 | 66.0 | 89.0 | 55.0 | 97.0 | 97.0 | 36.0 | 87.0 | 59.9 | 73.3 | 61.3 | 32.1 | 58.0 | 59.8 |
| @30° C. | | | | | | | | | | | | | | |
| Tensile modulus | 1.8 | 1.8 | 1.8 | 2.0 | 1.9 | 1.9 | 2.1 | 2.1 | NM | NM | 2.1 | 1.9 | 1.9 | 1.9 |
| (GPa) | | | | | | | | | | | | | | |
| Tensile strength | 56.8 | 56.4 | 57.2 | 57.5 | 57.6 | 55.1 | 59.4 | 52.9 | NM | NM | 54.5 | 49.5 | 50.0 | 59.1 |
| (MPa) | | | | | | | | | | | | | | |
| Tensile strain at break | 116.8 | 100.5 | 103.6 | 92.9 | 102.0 | 15.1 | 99.9 | 33.6 | NM | NM | 49 | 33.1 | 27.2 | 107.6 |
| (%) | | | | | | | | | | | | | | |
| Delamination | No | No | No | No | No | No | After | After | No | No | No | After | After | No |
| | | | | | | | 90% | 20% | | | | 20% | 20% | |
| | | | | | | | strain | strain | | | | strain | strain | |
| MVR | 25.0 | 10.0 | 12.0 | 15.0 | 9.8 | 18.0 | 18.0 | 16.0 | 14.2 | 15.0 | 11 | NM | NM | 11.3 |
| HDT (° C.) | 105 | 118 | 118 | 119 | 118 | 114 | 116 | 120 | 122 | 118 | 119 | 119 | 118 | 119 |

NM means Not Measured

The amounts in Table 2 are in weight percent based on the total weight of the composition. In all the examples, the total amount of components, equals 100 weight percent. Table 2 shows that the polycarbonate composition comprising the hydrogenated block copolymers shows comparable notch impact strength at room temperature (23° C.) as compared to CE1 which is a polycarbonate composition comprising ABS copolymer. The low temperature (−30° C.) impact of the PC-HBC compositions are also found to be higher than CE1, even at a lower loading of the impact modifier HBC in E1 to E7 compared to the impact modifier ABS loading in CE1. Thus, the polycarbonate compositions of the present invention show higher low temperature impact compared to PC-ABS compositions. Similarly, the tensile properties of all the compositions from E1 to E7, irrespective of styrene content in each of the HBCs used showed comparable values to the PC-ABS composition of CE1. However, compositions of E6 and E7 showed delamination during tensile-stress strain testing.

Additionally it was observed that the polycarbonate composition comprising the hydrogenated block copolymers showed better heat resistance property as demonstrated by the higher HDT values for E1 to E7 compared to the PC-ABS composition of CE1. Even with lower and higher ranges of HBC wt. %, in E8-E10, improvement in HDT was observed compared to CE1, without any delamination. Similar experiments were performed with vinyl bond rich un-hydrogenated block copolymers and hydrogenated block copolymers with vinyl rich bonds in E11 and E12. Both E11 and E12 showed comparable impact properties, but reduced tensile properties along with delamination was observed. Experiments with a composition comprising polycarbonate prepared by the melt transesterification process along with HBC in E13 showed comparable properties to similar compositions wherein the polycarbonate was prepared by the interfacial process. Improvement in impact properties, MVR and HDT was observed in E13 compared to CE1.

TABLE 3
Detailed VOC profiles for the PC - HBC compositions

| VOCs | CE 1 | E1 | E2 | E3 | E4 | E5 | E6 | E7 | E8 | E9 | E10 |
|---|---|---|---|---|---|---|---|---|---|---|---|
| Formaldehyde | 0.5 | ND | ND | ND | ND | ND | ND | ND | ND | ND | ND |
| Acetone | 0.1 | ND | ND | ND | ND | ND | ND | ND | ND | ND | ND |
| Acrylonitrile | 1.4 | ND | ND | ND | ND | ND | ND | ND | ND | ND | ND |
| Dichloromethane | 0.1 | 2.9 | 2.1 | 1.8 | 1.4 | 1.1 | 0.9 | 0.9 | ND | ND | ND |
| Ethyl acetate | 3.0 | ND | ND | ND | ND | ND | ND | ND | ND | ND | ND |
| Methyl | 1.9 | ND | ND | ND | ND | ND | ND | ND | ND | ND | ND |
| methacrylate | | | | | | | | | | | |
| Toluene | 0.4 | 0.4 | 0.4 | 0.4 | 0.5 | 0.2 | 0.3 | 0.4 | 0.5 | 0.8 | ND |
| Ethyl benzene | 41.9 | 0.3 | 0.3 | 0.4 | 0.4 | 0.2 | 0.4 | 0.5 | 0.2 | 0.8 | ND |
| Butene/methyl | ND | ND | ND | ND | ND | ND | ND | ND | ND | ND | 7.3 |
| propene | | | | | | | | | | | |
| Styrene | 173.0 | ND | ND | ND | ND | ND | ND | ND | ND | ND | ND |
| Benzaldehyde | 6.6 | ND | ND | ND | ND | ND | ND | ND | ND | ND | ND |
| Dichlorobenzene | 0.1 | ND | ND | ND | ND | ND | ND | ND | ND | ND | ND |
| Unknown VOC | 22.1 | 41.2 | 35.8 | 35.5 | 35.9 | 24.1 | 31.1 | 33.8 | 20.8 | 37.7 | 1.7 |
| Total VOC | 251.0 | 44.7 | 38.6 | 38.1 | 38.1 | 25.7 | 32.7 | 35.6 | 21.5 | 39.3 | 8.9 |

* ND means “not detected”

Table 3 shows the detailed VOC profiles as well as unknown VOC of the samples CE1 and E1 to E10. It can be seen from the Table-3 that CE1 has a relatively high amount of styrene along with other VOCs. However, E1 to E10 are found to have no detectable styrene and also the other volatiles are low. Therefore the total VOC of these PC compositions comprising the hydrogenated block copolymers are lower than PC-ABS composition. Hence for E1 to E10, we see a comparable or improved mechanical property of the compositions with low total VOC as compared to CE1.

1. A thermoplastic composition comprising, based on the weight of the composition,
(A) 75.0 to 98.9 wt. % of aromatic polycarbonate,
(B) 1.0 to 20.0 wt. % of at least one hydrogenated block copolymer which comprises at least one vinyl aromatic polymer block, and at least one hydrogenated diene polymer block and
(C) 0.1 to 5.0 wt. % of at least one additive;
wherein the combined amounts of (A), (B) and (C) is 100 wt. %, wherein, the composition has a total VOC of less than 75 mg/g.

2. The thermoplastic composition of claim 1, wherein in the hydrogenated block copolymer a weight ratio of hydrogenated diene polymer block to vinyl aromatic polymer block is from 90:10 to 30:70.

3. The thermoplastic composition of claim 1, wherein the vinyl aromatic polymer block is selected from the group consisting of polystyrene, alpha-methylstyrene polymer, vinyl toluene polymer, ethyl styrene polymer, propyl styrene polymer, butyl styrene polymer, styrene-alpha-methylstyrene copolymer and styrene-vinyl toluene copolymer.

4. The thermoplastic composition of claim 1, wherein the hydrogenated diene polymer block is selected from the group consisting of hydrogenated polybutadiene, hydrogenated polypentadiene, hydrogenated polyisoprene, and a hydrogenated copolymer of butadiene and isoprene.

5. The thermoplastic composition of claim 1, wherein each hydrogenated diene polymer block has a hydrogenation level of at least 95%.

6. The thermoplastic composition of claim 1, wherein the amount of hydrogenated block copolymer is from 5.0-15.0 wt. %.

7. The thermoplastic composition of claim 1, wherein, the at least one additive (C) does not comprise a poly(phenylene ether).

8. The thermoplastic composition of claim 1, wherein, the composition has a heat distortion temperature of more than 110° C., as determined in accordance with ISO 75 flatwise at a load of 0.45 MPa.

9. The thermoplastic composition of claim 1, wherein the weight average molecular weight of the hydrogenated block copolymer is from 70,000 to 450,000 g/mol determined using gel permeation chromatography with polystyrene standards.

10. The thermoplastic composition of claim 1, wherein the aromatic polycarbonate has a weight average molecular weight of 15,000 to 60,000 g/mol determined using gel permeation chromatography with polystyrene standards.

11. The thermoplastic composition of claim 1, wherein the aromatic polycarbonate comprises or consists of bisphenol-A polycarbonate homopolymer.

12. An article comprising or consisting of the thermoplastic composition of claim 1.

13. The article of claim 12 wherein said article is comprised in or constitutes any one or more selected from the group consisting of instrument panels, cup holders, glove boxes, dashboards, dashboard carriers, door claddings, door fixtures, armrests, pillar cladding, seat cladding, boot cladding and parts used in heating, ventilation and/or air conditioning instruments.

14. A vehicle or an electrical equipment comprising the article of claim 12.

15. A method for the manufacture of an article, the method comprising forming the article from the thermoplastic composition of claim 1.
